(19) United States
(12) Patent Application Publication
(10) Pub. No.: US 2023/0177094 A1
(43) Pub. Date: Jun. 8, 2023

(54) FAN DRIVEN PERFORMANCE ORGANIZATION

(71) Applicant: StageWood Consortium, Inc., Miami Beach, FL (US)

(72) Inventor: Santiago Figuereo, Miami, FL (US)

(21) Appl. No.: 17/542,065

(22) Filed: Dec. 3, 2021

(51) Int. Cl. G06F 16/9536; G06F 16/9537; G06Q 10/10

(52) U.S. Cl. CPC G06F 16/9536; G06F 16/9537; G06Q 10/1093

(57) ABSTRACT

Embodiments of the present invention provide for crowd-sourced formulation and scheduling of a public performance. A method for fan-driven performance organization includes collecting, from different members of a fan Web site, a selection of fan votes referring to a single performer, querying an availability record for the availability of the single performer and identifying a venue within a geographic proximity of a portion of the members, each indicating availability at times consistent with the available times at which the single performer is free to perform. Finally, the method includes responding to the identification of the selected venue by the scheduling a previously unscheduled performance by the single performer at the selected venue, and also the publication of the performance on the fan Web site in connection with the selected venue.

### BACKGROUND OF THE INVENTION

### Field of the Invention

The present invention relates to the field of concert promotion and more particularly to the crowd-sourced scheduling of a concert performance.

### Description of the Related Art

Concert promotion refers to the any portion of the process of planning, marketing and producing a live performance by an entertainer to a large group of spectators. While customarily associated with musical and comedic performances, concert promotion also encompasses orchestral performances, political and celebrity appearances, theater both traveling and fixed location, symphony, sporting events and live spectacles such as tradeshows, auto shows, air shows, boat shows and the like. The general features of concert promotion include the selection of a venue at a specific geographic location for use on a specific date, and the selection of one or more performers to perform at the selected venue on the specific date.

Much of concert promotion is reflects and exercise in scheduling in which the promoter selects a performer likely to draw a maximized audience willing to purchase an entrance ticket to the selected venue on the appointed date in order to experience the performance. The choice of venue largely depends upon the capacity of the venue and the ability for the selected performer to draw enough commercial interest in paying attendees to fill the available seats within the venue. As can be seen, then, for the concert goer, the ability to attend a concert performance of interest at a convenient time and date at a venue geographically proximate to the concert goer largely depends upon the choices of a single individual or small group of individuals charged with the responsibility to schedule concert performances irrespective of the precise identity of the chosen performer, selected venue and chosen date of the performance.

The task of arranging a concert performance, then, can be quite complex and given the seemingly vast number of available performance and the unprecedented diversity of taste amongst prospective concert goers, the task of optimally arranging a concert performance can be nearly impossible for such a small number of decision makers. Consequently, venues remain vacant, sub-optimally utilized, and so many prospective performers remain on the sidelines, untapped at times when the performer is otherwise able to perform. Most importantly, the consuming community of prospective concert goers remain unsatisfied in their inability to attend a live performance of an entertainer of choice at a venue of reasonable geographic proximity and on a date of convenience.

### BRIEF SUMMARY OF THE INVENTION

Embodiments of the present invention address deficiencies of the art in respect to concert promotion and provide a novel and non-obvious method, system and computer program product for crowd-sourced formulation and scheduling of a public performance. In an embodiment of the invention, a method for fan-driven performance organization includes the collection, from different members of a fan Web site, a selection of fan votes referring to a single performer. The method also includes querying an availability record for the availability of the single performer and the identification of one or more venues within a geographic proximity of a portion of the different members, each indicating availability at times consistent with the available times at which the single performer is free to perform. Finally, the method includes responding to an identification of a selected venue within geographic proximity of a portion of the different members and with availability at times consistent with available times for the single performer set forth in the availability record, by the scheduling of a previously unscheduled performance by the single performer at the selected venue, and also the publication of the performance on the fan Web site in connection with the selected venue.

In one aspect of the embodiment, the fan votes are received from respectively different mobile application clients over a computer communications network. In another aspect of the embodiment, it can be determined from the availability record, minimum venue criteria so that the venues can be filtered before the identification to include only those of the venues meeting the minimum venue criteria. In yet another aspect of the embodiment, the method additionally includes the periodic scanning of different performance schedules for different performers over a computer communications network, with each of the performance schedules referring to one of the different performers, a multiplicity of dates and corresponding venues. Consequently, the availability record for each of the different performers may be updated with the different performance schedules for the different performers.

In even yet another aspect of the embodiment, the method additionally includes storing with each of the fan votes, a corresponding geographic location of a subscriber submitting a corresponding one of the fan votes, and computing a frequency distribution of the fan votes by geographic location. Then, one of the venues can be selected based additionally upon the selected venue residing at the corresponding geographic location computed to have a greatest frequency within the distribution. Optionally, multiple ones of the geographic location within a threshold geographic proximity to one another can be grouped into an associated geographic region so that the frequency distribution is computed for the associated geographic region.

In another embodiment of the invention, a data processing system is adapted for fan-driven performance organization includes a host computing platform with one or more computers, each having memory and at least one processor. The system also includes a performance scheduling module including computer program instructions. The instructions are enabled while executing in the host computing platform to collect from different members of a fan Web site a selection of fan votes referring to a single performer, query an availability record for availability of the single performer and identify one or more venues within a geographic proximity of a portion of the different members with availability at times consistent with available times for the single performer. The instructions additionally are enabled to respond to an identification of a selected venue within the geographic proximity of the portion of the different members with availability at times consistent with available times for the single performer set forth in the availability record, by scheduling a previously unscheduled performance by the single performer at the selected one of the venues and publishing on the fan Web site the scheduled performance by the single performer at the selected one of the venues.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is pictorial illustration of a process for fan-driven performance organization;

FIG. 2 is a schematic diagram of a data processing system adapted for fan-driven performance organization; and,

FIG. 3 is a flow chart illustrating a process for fan-driven performance organization.

### DETAILED DESCRIPTION OF THE INVENTION

Embodiments of the invention provide for fan-driven performance organization. In accordance with an embodiment of the invention, different performance requests can be received from different end user devices from over a computer communications network. Each of the requests specifies a specific performer and a geographic location of a corresponding end user associated with the request. Thereafter, a performer having been the subject of a threshold number of the requests can be selected and an availability record for the selected performer can be consulted to determine dates on which the selected performer is available to perform and any venue criteria which must be met for the selected performer. A venue is then determined which is most proximate to a largest number of end users corresponding to the threshold number of requests and, to the extent the venue satisfies the venue criteria, the venue can be reserved for a performance by the selected performer and the performance can be published over the computer communications network. In this way, a technical improvement to the well-worn process of the electronic scheduling of performances is achieved by optimizing a selection of a most desirable performer to perform at a venue for a geographic location most proximate to a plurality of those prospective fans most likely to purchase tickets to the performance.

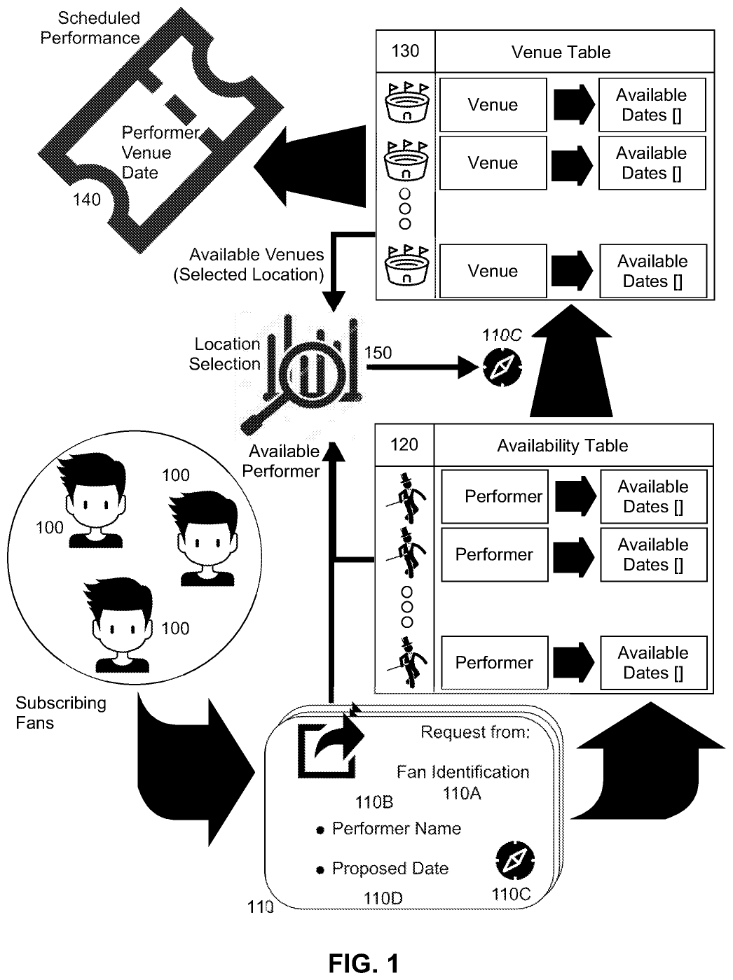

In further illustration, FIG. 1 pictorially shows a process for fan-driven performance organization. As shown in FIG. 1, different fans 100 submit different requests 110 for the organization of a performance. Each of the requests 110 include an identification 110A of a submitting one of the fans 110, a name of the performer 110B and a location 110C associated with the submitting one of the fans 110. Optionally, each of the requests 110 includes a proposed date or range of dates 110D when the performance is to be organized.

When a threshold number of the requests 110 specify a specific performer, an availability table 120 may then be consulted to determine on which dates the specific performer is available to perform, e.g. not already scheduled to perform. Then, location selection logic 150 identifies a geographic location 110C of greatest predominance amongst the requests 110 specifying the specific performer and queries a venue table 130, for one or more venues proximate to the geographic location 110 of greatest predominance that has availability for the determined dates. Finally, a performance 140 is scheduled for the specific performer at the selected venue for the specified date and published to each of the subscribing fans 100.

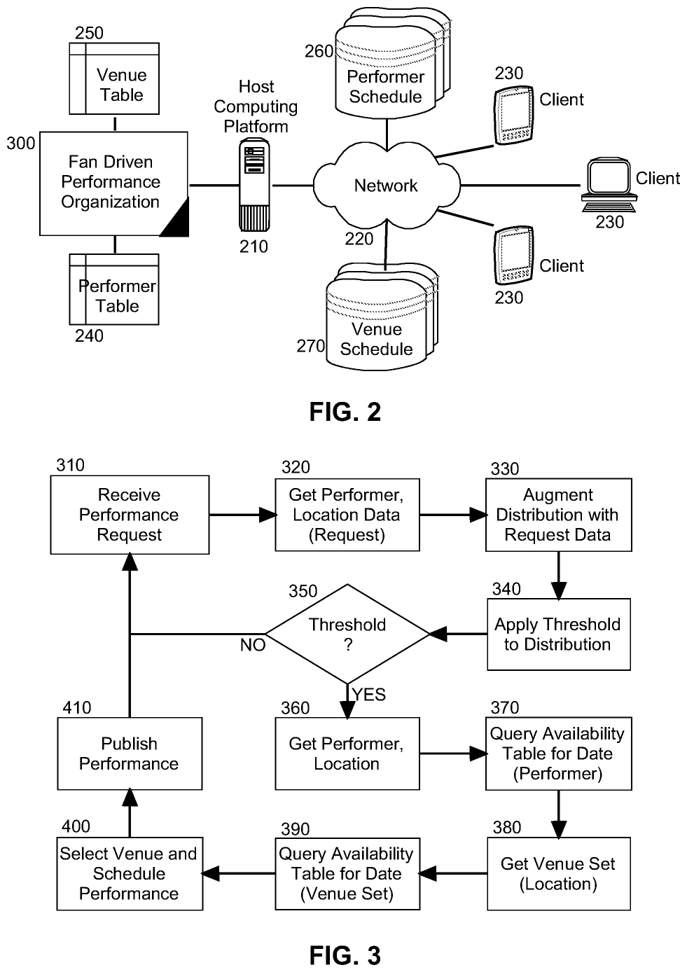

The process described in connection with FIG. 1 may be implemented within a computer data processing system. In further illustration, FIG. 2 schematically shows a data processing system adapted for fan-driven performance organization. The system includes a host computing platform 210 that includes one or more computers, each with memory and at least one processor. The host computing platform 210 is communicatively coupled over computer communications network 220 to different computing clients 230 from which different requests to organize a performance by a performer may be received.

Of note, the system includes a fan driven performance organization module 300. The module 300 includes computer program instructions that when executing in the memory of the host computing platform 210, are enabled to maintain a performer table 240 in which an availability of different performers on different dates are stored. In this regard, the performer table 240 may be populated by issuing one or more queries against different data stores 260 specifying different schedules for different performers, including one or more Web pages published in respect to the different performers. As well, the program instructions are enabled to maintain a venue table 250 in which an availability of different venues at different locations are stored for different dates. Like the performer table 240, the venue table 250 may be populated by issuing one or more queries against different data stores 270 specifying different schedules for different venues, including one or more Web pages published in respect to the different venues.

Notably, the program instructions even further are enabled to determine from a group of received requests, a threshold number of requests for a specific performer and further to determine from amongst the threshold number of requests, a predominant location common to a threshold number of requesting fans. The program instructions then are enabled to query the performer table 240 in order to determine dates on which the specific performer is available to perform. The program instructions also are enabled to query the venue table 250 in order to locate one or more venues available on the determined date or dates. Yet further, the program instructions are enabled to select one of the available venues corresponding to a location common amongst a threshold number of fans submitting requests to organize a performance by the specific performer. Finally, the program instructions are enabled to generate request messages to computing systems associated with the selected one of the available venues and specific performer so as to organize a performance by the specific performer at the selected one of the available venues, and the program instructions can publish to the client devices 230 a visual display of the organized performance.

In even yet further illustration of the operation of the fan driven performance organization module 300, FIG. 3 is a flow chart illustrating a process fan-driven performance organization. Beginning in block 310, a performance request from a mobile device of one of a multiplicity of subscribing fans, is received from over a computer communications network and in block 320, a specified performer, and location data corresponding to a source of the request is retrieved from the request. In this regard, the location data can be determined in connection with an identity of the requestor as previously stored when the requestor registers with the system, or the location data can be ascertained from a network address from which the request originates. Thereafter, in block 330, a distribution of requests by performer can be augmented to account for the newly received request.

In block 340, a threshold number is applied to the distribution in order to determine in decision block 350 whether or not a specific performer has received a threshold number of requests. If not, the process returns to block 310 with a receipt of a subsequent request. But if so, in block 360, the performer associated with a threshold number of requests is identified along with a distribution of locations for the different requests for the specific performer. In block 370, an availability record for the performer is retrieved to determine dates on which the performer is available to schedule a performance.

In block 380, a set of venues with a particular location associated with a threshold number of the requests in the distribution are retrieved and queried in block 390 in order to determine which if any are available to schedule a performance. Optionally, the venues are filtered to limit the venues in the set to only those venues of minimum characteristics matching minimum criteria stored in connection with the performer, such as minimum seating, indoor or outdoor seating, etc. Then, in block 400, one of the venues in the set determined to be available is selected to host a performance by the performer and in block 410, once the performance is scheduled, a notification of the performance is published to the mobile devices of the subscribing fans.

The present invention may be embodied within a system, a method, a computer program product or any combination thereof. The computer program product may include a non-transitory computer readable storage medium or media having computer readable program instructions stored thereon, which when executed within the computer, cause one or more processors to perform different processes exemplary of different aspects of the present invention. To that end, the non-transitory computer readable storage medium can be a tangible device that can retain and store instructions for use by an instruction execution device such as a processor (central processing unit or “CPU”).

Aside from direct loading from memory for execution by one or more cores of a CPU or multiple CPUs, the computer readable program instructions described herein alternatively can be downloaded from over a computer communications network into the memory of a computer for execution therein. As well, only a portion of the program instructions may be retrieved into memory of the computing device from over a computer communications network, while other portions may be loaded from persistent storage of the computing device. Even further, only a portion of the program instructions may execute by one or more processing cores of one or more CPUs of the computing devices while other portions may cooperatively execute within a different computing device positioned remotely over the computer communications network with results of the computing by both devices shared therebetween.

Even yet further, as it is to be understood, one or more aspects of the present invention have been described herein with reference to flowchart illustrations and/or block diagrams of methods, apparatus (data processing systems), and computer program products according to embodiments of the invention. It will be understood that each block of the flowchart illustrations and/or block diagrams, and combinations of blocks in the flowchart illustrations and/or block diagrams, can be implemented by computer readable program instructions in various combinations. These computer readable program instructions may be provided to a CPU of a general-purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks. The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function or functions. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “include”, “includes”, and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for fan-driven performance organization comprising:
collecting from different members of a fan Web site a selection of fan votes referring to a single performer;
querying an availability record for availability of the single performer;
identifying one or more venues within a geographic proximity of a portion of the different members with availability at times consistent with available times for the single performer; and,
responsive to an identification of a selected one of the venues within the geographic proximity of the portion of the different members with availability at times consistent with available times for the single performer set forth in the availability record,
scheduling a previously unscheduled performance by the single performer at the selected one of the venues and publishing on the fan Web site the scheduled performance by the single performer at the selected one of the venues.

2. The method of claim 1, wherein the fan votes are received from respectively different mobile application clients over a computer communications network.

3. The method of claim 1, further comprising periodically scanning different performance schedules for different performers over a computer communications network, each of the performance schedules referring to one of the different performers, a multiplicity of dates and corresponding venues, and updating the availability record for each of the different performers with the different performance schedules for the different performers.

4. The method of claim 1, further comprising storing with each of the fan votes, a corresponding geographic location of a subscriber submitting a corresponding one of the fan votes, computing a frequency distribution of the fan votes by geographic location and selecting the one of the venues based additionally upon the selected one of the venues residing at the corresponding geographic location computed to have a greatest frequency within the distribution.

5. The method of claim 4, wherein multiple ones of the geographic location within a threshold geographic proximity to one another are grouped into an associated geographic region and the frequency distribution is computed for the associated geographic region.

6. The method of claim 1, further comprising determining from the availability record minimum venue criteria and filtering the venues before the identification to include only those of the venues meeting the minimum venue criteria.

7. A data processing system adapted for fan-driven performance organization, the system comprising:
a host computing platform comprising one or more computers, each comprising memory and at least one processor; and,
a performance scheduling module comprising computer program instructions enabled while executing in the host computing platform to perform:
collecting from different members of a fan Web site a selection of fan votes referring to a single performer;
querying an availability record for availability of the single performer;
identifying one or more venues within a geographic proximity of a portion of the different members with availability at times consistent with available times for the single performer; and,
responsive to an identification of a selected one of the venues within the geographic proximity of the portion of the different members with availability at times consistent with available times for the single performer set forth in the availability record,
scheduling a previously unscheduled performance by the single performer at the selected one of the venues and publishing on the fan Web site the scheduled performance by the single performer at the selected one of the venues.

8. The system of claim 7, wherein the fan votes are received from respectively different mobile application clients over a computer communications network.

9. The system of claim 7, wherein the program instructions are further enabled to perform periodically scanning different performance schedules for different performers over a computer communications network, each of the performance schedules referring to one of the different performers, a multiplicity of dates and corresponding venues, and updating the availability record for each of the different performers with the different performance schedules for the different performers.

10. The system of claim 7, wherein the program instructions are further enabled to perform storing with each of the fan votes, a corresponding geographic location of a subscriber submitting a corresponding one of the fan votes, computing a frequency distribution of the fan votes by geographic location and selecting the one of the venues based additionally upon the selected one of the venues residing at the corresponding geographic location computed to have a greatest frequency within the distribution.

11. The system of claim 10, wherein multiple ones of the geographic location within a threshold geographic proximity to one another are grouped into an associated geographic region and the frequency distribution is computed for the associated geographic region.

12. The system of claim 10, wherein the program instructions are further enabled to perform determining from the availability record minimum venue criteria and filtering the venues before the identification to include only those of the venues meeting the minimum venue criteria.

13. A computer program product for fan-driven performance organization, the computer program product including a computer readable storage medium having program instructions embodied therewith, the program instructions executable by a device to cause the device to perform a method including:
collecting from different members of a fan Web site a selection of fan votes referring to a single performer;
querying an availability record for availability of the single performer;
identifying one or more venues within a geographic proximity of a portion of the different members with availability at times consistent with available times for the single performer; and,
responsive to an identification of a selected one of the venues within the geographic proximity of the portion of the different members with availability at times consistent with available times for the single performer set forth in the availability record,
scheduling a previously unscheduled performance by the single performer at the selected one of the venues and publishing on the fan Web site the scheduled performance by the single performer at the selected one of the venues.

14. The computer program product of claim 13, wherein the fan votes are received from respectively different mobile application clients over a computer communications network.

15. The computer program product of claim 13, wherein the method further comprises periodically scanning different performance schedules for different performers over a computer communications network, each of the performance schedules referring to one of the different performers, a multiplicity of dates and corresponding venues, and updating the availability record for each of the different performers with the different performance schedules for the different performers.

16. The computer program product of claim 13, wherein the method further comprises storing with each of the fan votes, a corresponding geographic location of a subscriber submitting a corresponding one of the fan votes, computing a frequency distribution of the fan votes by geographic location and selecting the one of the venues based additionally upon the selected one of the venues residing at the corresponding geographic location computed to have a greatest frequency within the distribution.

17. The computer program product of claim 16, wherein multiple ones of the geographic location within a threshold geographic proximity to one another are grouped into an associated geographic region and the frequency distribution is computed for the associated geographic region.

18. The computer program product of claim 13, wherein the method further comprises determining from the availability record minimum venue criteria and filtering the venues before the identification to include only those of the venues meeting the minimum venue criteria.
